(19) United States
(12) Patent Application Publication
(10) Pub. No.: US 2026/0126096 A1
(43) Pub. Date: May 7, 2026

(54) BUNGEE INTERCONNECTION SYSTEM

(71) Applicant: Nite Ize, Inc., Boulder, CO (US)

(72) Inventor: Bowden ORMSBEE, Longmont, CO (US)

(21) Appl. No.: 19/372,046

(22) Filed: Oct. 28, 2025

Related U.S. Application Data
(60) Provisional application No. 63/716,852, filed on Nov. 6, 2024.

(51) Int. Cl. F16G 11/04

(52) U.S. Cl. CPC F16G 11/046

(57) ABSTRACT

An assembly for attachment to an end of a cord that facilitates interconnection to another device. The device defines an opening through which the cord extends. The cord includes an end portion, such as a loop, ferrule positioned about the loop, that secures a ring configured to be positioned adjacent the opening to prevent withdrawal of the cord from the device when cord tension is applied. The assembly enables secure and durable attachment of the cord to the device without crimp sleeves or end caps and allows simplified assembly using conventional cord materials and diameters.

This application claims the benefit of U.S. Provisional Patent Application Ser. No. 63/716,852, filed Nov. 6, 2024, which is incorporated by reference herein under 37 C.F.R. § 1.57.

### FIELD OF THE INVENTION

Embodiments of the present invention generally relate to elastic cord fastening systems and, more particularly, to systems and methods for connecting an end of an elastic or bungee cord to another component, such as a hook.

### BACKGROUND OF THE INVENTION

The following background discussion is not an admission that the matters discussed below are citable as prior art or common general knowledge. Rather, the general background information disclosed is directed at describing the problem(s) associated with the current state of the art, and a need for a better solution.

Elastic cords, often referred to as bungee cords or shock cords, are widely used to secure or tension objects in transportation, recreation, and industrial applications. Various devices have been developed to attach such cords to hooks, clips, or other anchoring elements.

In one known approach, a molded plastic hook includes one or more holes at its base end through which the cord is threaded and tied in a knot, as shown in U.S. Pat. No. 4,831,692. The knot prevents the cord from being withdrawn from the hook body under tension. Another common design employs an internal cavity within the hook body that receives a doubled-over cord end secured by a crimp sleeve or end cap, as described in U.S. Pat. No. 5,546,639. Similar constructions use channels or wedges to frictionally grip a cord when tensioned, such as the arrangement disclosed in U.S. Pat. No. 4,340,998. As shown in U.S. Publication No. 2012/0102680, hooks that have multiple apertures that receive a cord in a circuitous fashion, thereby increasing frictional, i.e. holding, force between the cord in the hook, have also been used. In still other arrangements, a looped cord end is crimped with a ferrule or metal ring, and the hook is engaged through the loop, as described in U.S. Pat. No. 5,638,584.

FIG. 1 shows a common method of connecting a cord 2 to a device for interconnection 6, such as a hook. Here, an end 10 of the bungee cord is threaded through an end opening 14 and a side opening 16 in the device for interconnection 6 and looped upon itself. The loop 18 is maintained by a length of ductile metallic material 22 in a coiled fashion. In operation, pulling the cord 2 away from the device for interconnection 6 will eventually position the loop 18 and/or ferrule 22 within a seat 30 associated with the side opening 16. Because the loop and/or ferrule are wider than the side opening 16, the cord 2 cannot be removed from the device for interconnection 6. One drawback with this configuration is that excessive tensile forces may tend to deform the compliant cord/loop and more rigid ferrule, thereby allowing the cord 2 to slip out of the ferrule.

Although these known devices provide various mechanisms for attaching a cord to a hook, they often require additional parts such as crimp sleeves or end caps or depend on knots that can loosen or degrade with use. Some designs also involve multiple assembly steps or rely on frictional engagement that may vary with cord diameter and elasticity. Accordingly, there remains a need for an improved hook and cord interface that provides secure and durable attachment, simplified assembly, and reliable performance under repeated tensioning and environmental exposure.

### SUMMARY OF THE INVENTION

Embodiments of the present invention provide an improved system for interconnecting an elastic or bungee cord to another component, such as a hook, without requiring additional crimp sleeves, caps, or adhesive bonding. Accordingly, retention and durability of the connection is enhanced.

In one embodiment, the invention provides a device for interconnection, such as a hook, having an end opening and a side opening that together define a channel through which an end of a cord is routed. The cord end is folded upon itself to form a loop maintained by a ferrule. A ring is captured within the loop. The engagement of the ferrule onto an end wall of the seat transfers tensile forces from the cord to the device for interconnection.

As one of skill in the art will appreciate, the cord will narrow when tensioned. The ring is configured to prevent or decrease loop deformation that would otherwise allow the cord to escape the ferrule and release the cord from the device for interconnection. The ferrule and/or the ring may also engage sidewalls of the seat to enhance engagement. The channel of one embodiment has tapered or contoured sidewalls that direct the cord along a defined path and guide the ferrule, ring, and/or cord into a secure, seated position.

In certain embodiments, the ferrule or ring includes external features such as barbs, knurls, or surface texture that facilitates frictional engagement between the ring and the sidewalls, or to allow for the ring to deform the sidewalls to firmly seat the ring.

This configuration provides a compact, durable, and easily assembled interconnection system. Using a ring and seat arrangement eliminates reliance on frictional knots or compressive crimps, reduces the risk of cord slippage or deformation under load, and distributes tension forces evenly through the loop, ferrule, and/or ring. The invention therefore improves safety, extends service life, and provides reliable performance across a range of cord diameters and materials.

It is one aspect to provide an assembly configured for securing an object comprising: device adapted for selectively interconnecting to an anchor point, the device having a seat with a channel extending therethrough, wherein channel ends are define by an end opening and a side opening; a cord within the channel and extending through the end opening and the side opening; and wherein an end of the cord forms a loop that defines a space configured to accommodate a ring configured to prevent the cord from slipping from the ferrule.

It is another aspect of some embodiments to provide a device for interconnection, comprising: a body having an end opening and a side opening that define a channel; a seat formed within the channel; a cord having an end portion extending through the end opening and the side opening, the cord terminating in a loop; a ferrule positioned about the loop; and a load-transfer means captured within the loop, wherein the load-transfer means configured to prevent the loop slipping from the ferrule.

It is still yet another aspect of embodiments of the present invention to provide a method of assembling a cord interconnection system, comprising: providing a device for interconnection having an end opening and a side opening that define ends of channel with a seat positioned therein; threading an end portion of a cord through the end opening and the side opening; forming a loop in the cord; positioning a ring within the loop; securing the loop by applying a ferrule therearound to maintain the ring in a captured position; and locating at least one of the cord, ferrule, and the ring within the channel such that, when tension is applied to the cord, the loop is at least partially prevented from slipping from the ferrule.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of a conventional hook and elastic cord assembly representative of the prior art.

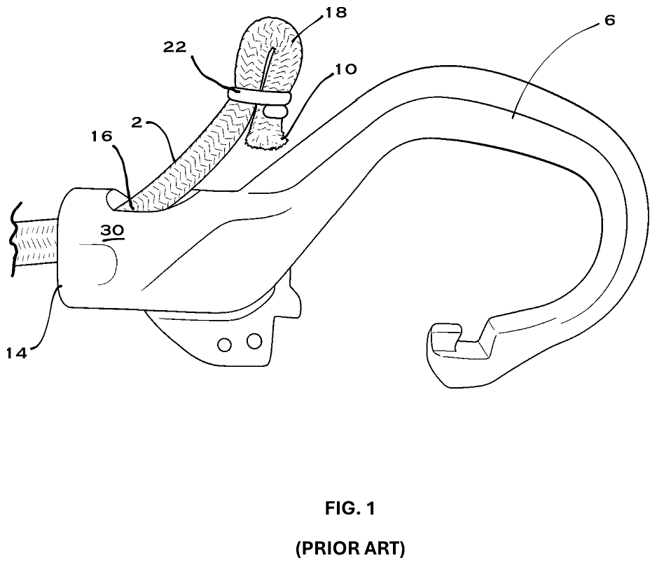

FIG. 2 is a perspective view of a hook according to one embodiment of the present invention showing the general configuration of a hook and an attached elastic cord.

FIG. 3 is a side elevation view of the configuration of FIG. 2, wherein a retaining ring is located in a seat.

FIG. 4 is a cross sectional view of the configuration of FIG. 3.

FIG. 5 is a detailed partial perspective view showing a ferrule and ring seated in a cavity.

FIG. 6 is a top perspective view showing the configuration of FIG. 3.

The following component list and associated numbering found in the drawings is provided to assist in the understanding of one embodiment of the present invention:

| # | Component |
|---|---|
| 2 | Cord |
| 6 | Device for interconnection |
| 10 | Cord end |
| 14 | End opening |
| 16 | Side opening |
| 18 | Loop |
| 22 | Ferrule |
| 30 | Seat |
| 34 | Ring |
| 38 | Sidewall |
| 40 | End wall |
| 44 | Channel |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

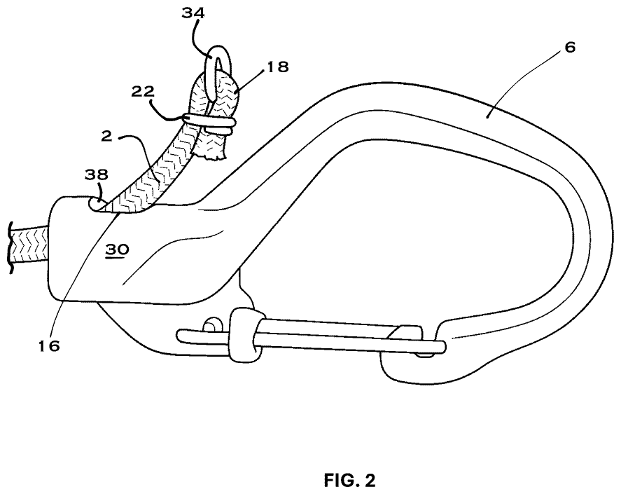

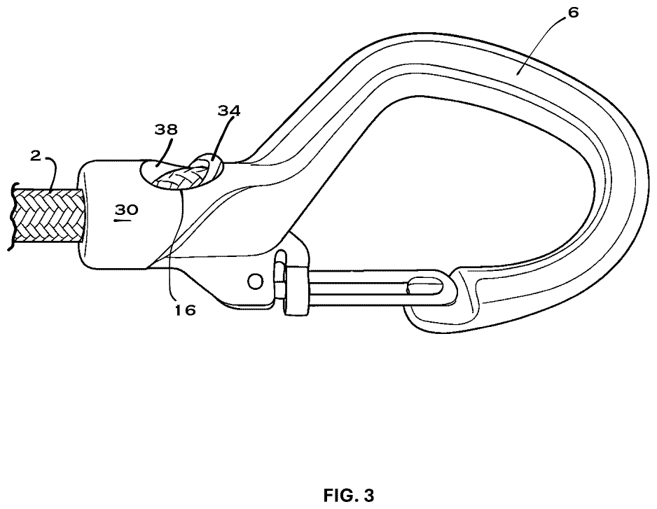

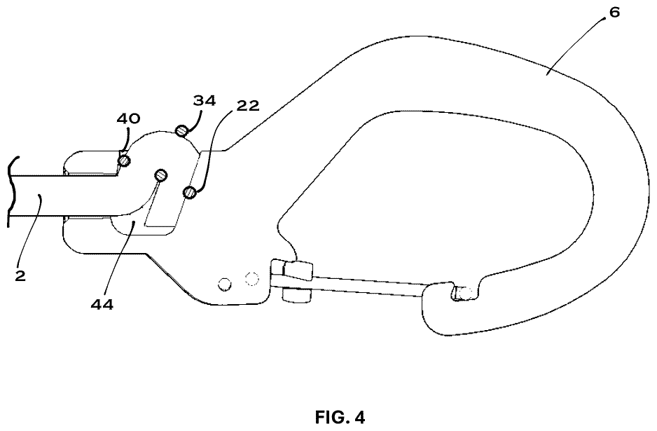

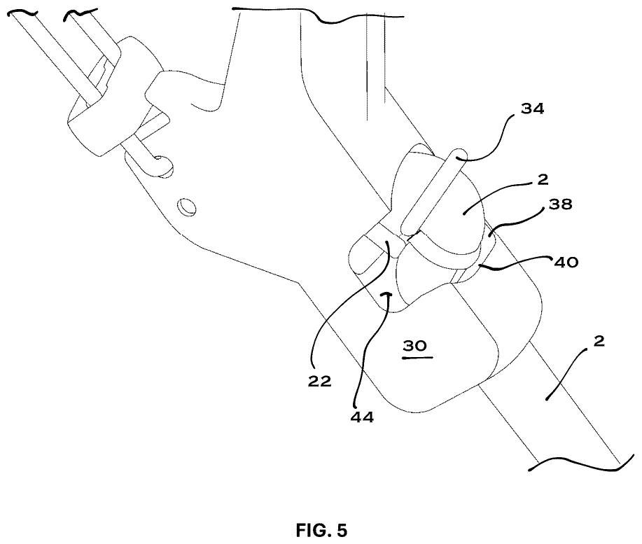

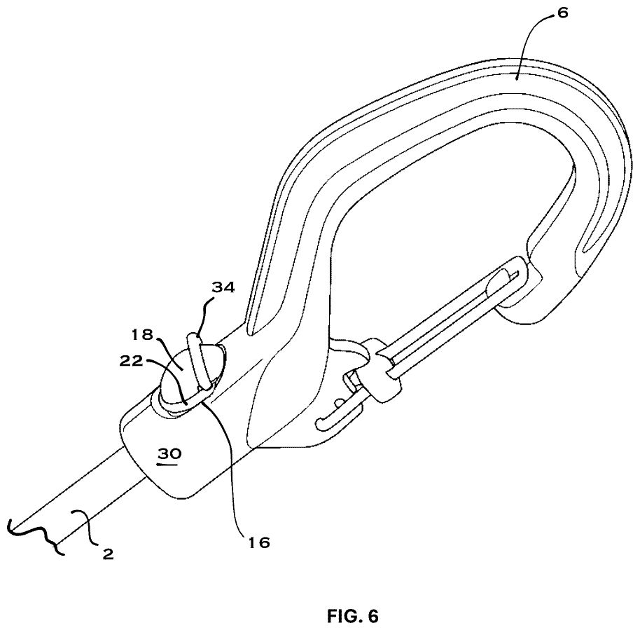

FIGS. 2-6 show a configuration of one embodiment of the present invention wherein a loop 18 in a cord 2 and a ferrule 22 captures and maintains a ring 34. Upon application of cord tension, the ferrule will 22 will engage internal sidewalls 38 and/or an end wall 40 of a seat 30. A channel 44 defined by an end opening 14, a side opening 16, sidewalls 38, and the end wall 40 accommodates the cord 2, the ferrule 22, and at least a portion of the ring 34. The channel 44 is configured such that portions of the ferrule 22 and ring 34 can pass through the side opening 16, but the end wall 40 prevents movement of the ferrule out of the end opening 14. That is, the loop 18, ferrule 22, and/or ring 34 has an outer extent greater than the end opening 14 and/or a distance between sidewalls 38. Thus, cord tension is transferred from the cord to the device for interconnection 6 through the loop 18 and/or ferrule 22.

The cord 2 is maintained within the loop by the ring 34, which addresses the disadvantages of the prior art mentioned above. The ring 34 may be metallic, polymeric, or composite and may have a generally circular profile as shown, or any other shape capable of performing a comparable function.

The term “ring” as used herein should be understood broadly to encompass any member captured within the loop 18 and configured to maintain the loop when the cord 2 is tensioned. Suitable member shapes include, by way of example and not limitation, oval, elliptical, triangular, rectangular, or polygonal. The member may be in the form of split rings, curved or arched bars, collars, crimp sleeves, ferrules, plugs, bushings, pins, ball-type members, wedges, or any equivalent structure.

In certain embodiments, the ferrule may be deformable or expandable, such as a spring clip, a compressible ferrule, a C-shaped retainer, or an expanding wedge configured to seat under tension. Other embodiments may employ a molded or over-molded insert, an elastomeric grommet or plug, or a heat-formed collar integrally formed with the cord itself. Still other configurations may include textile-based or braided enlargements, wrapped fiber bundles, or resin-impregnated ends of the cord that function as an integral load-transfer member. The ferrule may also include external surface features such as barbs, knurls, teeth, or high-friction coatings to enhance engagement with the sidewalls 38. In yet other embodiments, a magnetic or composite insert may interact with ferromagnetic seat components to resist withdrawal.

Regardless of its specific configuration, each of the foregoing structures functions as a means for transferring tension from the cord 2 to the device for interconnection 6 and, with respect to the ring 34, for preventing the cord 2 from disengaging from the loop 18 or ferrule 22 during use. Accordingly, references to a “ferrule” or “load-transfer member” are intended to include all mechanical, deformable, or equivalent elements that perform substantially the same function in substantially the same way to achieve substantially the same result, namely, the transmission of tension forces between the cord and the interconnection device.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment, or with the concepts disclosed in the patents or applications incorporated by reference herein. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. An assembly configured for securing an object comprising:
device adapted for selectively interconnecting to an anchor point, the device having a seat with a channel extending therethrough, wherein channel ends are define by an end opening and a side opening;
a cord within the channel and extending through the end opening and the side opening; and
wherein an end of the cord forms a loop that defines a space configured to accommodate a ring configured to prevent the cord from slipping from the ferrule.

2. The assembly of claim 1, wherein the device includes a hook.

3. The assembly of claim 1, wherein cord is elastic.

4. The assembly of claim 1, wherein the channel includes an end wall configured to selectively engage a ferrule that maintains the loop.

5. The assembly of claim 4, wherein the channel has an inner profile that is less than an outer extent of at least one of the loop, the ferrule, or the ring.

6. The assembly of claim 4, wherein the ring or ferrule has a textured or knurled outer surface.

7. The assembly of claim 1, wherein the loop is maintained by a ferrule, and the ring and/or ferrule comprise an integral portion of the cord.

8. The assembly of claim 7, wherein the ferrule is comprised of a compliant metallic material.

9. The assembly of claim 7, wherein tension on the cord urges the ferrule against a surface of the channel and/or side opening portions.

10. A device for interconnection, comprising:
a body having an end opening and a side opening that define a channel;
a seat formed within the channel;
a cord having an end portion extending through the end opening and the side opening, the cord terminating in a loop;
a ferrule positioned about the loop; and
a load-transfer means captured within the loop, wherein the load-transfer means configured to prevent the loop slipping from the ferrule.

11. The device of claim 10, wherein channel sidewalls are tapered such that a width thereof decreases along its length, and wherein the channel includes an end wall that selectively receives the ferrule.

12. The device of claim 10, wherein the channel includes contoured surfaces.

13. The device of claim 10, wherein the ferrule and/or load-transfer means includes external surface features configured to enhance frictional engagement with the sidewalls.

14. The device of claim 13, wherein the external surface features comprise barbs, knurls, or raised texture.

15. The device of claim 10, wherein the ferrule comprises a ductile metallic material wrapped around the loop to maintain the loop and retain the load-transfer means.

16. The device of claim 10, wherein the body comprises a hook having a curved portion and a base portion, the side opening being located in the base portion adjacent the seat.

17. The device of claim 10, wherein the sidewalls of the seat are configured to flex or elastically deform to permit partial passage of the load-transfer means.

18. A method of assembling a cord interconnection system, comprising:
providing a device for interconnection having an end opening and a side opening that define ends of channel with a seat positioned therein;
threading an end portion of a cord through the end opening and the side opening;
forming a loop in the cord;
positioning a ring within the loop;
securing the loop by applying a ferrule therearound to maintain the ring in a captured position; and
locating at least one of the cord, ferrule, and the ring within the channel such that, when tension is applied to the cord, the loop is at least partially prevented from slipping from the ferrule.

19. The method of claim 18, further comprising tapering the sidewalls of the channel such that a spacing between the sidewalls decreases along the channel's length.

20. The method of claim 18, wherein at least one of the ferrule and the ring includes external surface features that frictionally engage the sidewalls of the channel.
